(19) United States
(12) Patent Application Publication
(10) Pub. No.: US 2009/0194483 A1
(43) Pub. Date: Aug. 6, 2009

(54) MICROFLUIDIC DEVICE HAVING MONOLITHIC SEPARATION MEDIUM AND METHOD OF USE

(76) Inventors: Karla M. Robotti, Cupertino, CA (US); Hongfeng Yin, Cupertino, CA (US)

Correspondence Address: AGILENT TECHNOLOGIES INC., INTELLECTUAL PROPERTY ADMINISTRATION,LEGAL DEPT., MS BLDG. E P.O. BOX 7599, LOVELAND, CO, 80537, US

(21) Appl. No.: 12/023,524

(22) Filed: Jan. 31, 2008

(51) Int. Cl. B01D 15/08

(52) U.S. Cl. 210/659; 210/198.2

(57) ABSTRACT

A microfluidic device, a device including the microfluidic device and methods of operation are described.

### BACKGROUND

Chemical and biological separations are routinely performed in various industrial and academic settings to determine the presence and/or quantity of individual species in complex sample mixtures. There exist various techniques for performing such separations.

One particularly useful analytical process is chromatography, which encompasses a number of methods that are used for separating ions or molecules for analysis. Liquid chromatography (‘LC’) is a physical method of separation wherein a liquid ‘mobile phase’ carries a sample containing multiple molecules or ions for analysis (analytes) through a separation medium or ‘stationary phase.’ Stationary phase material typically includes a liquid-permeable medium such as packed granules (particulate material) or a microporous matrix (e.g., porous monolith) disposed within a tube or similar boundary. The resulting structure including the packed material or matrix contained within the tube is commonly referred to as a ‘separation column.’ In the interest of obtaining greater separation efficiency, so-called ‘high performance liquid chromatography’ (‘HPLC’) methods often utilizing high operating pressures are commonly used.

In recent years, microdevice technologies, also referred to as microfluidic technologies and Lab-on-a-Chip technologies, have been used in LC and HPLC applications. These microdevices are useful in many applications, particularly in applications that involve rare or expensive analytes, such as proteomics and genomics. Furthermore, the small size of the microdevices allows for the analysis of minute quantities of sample.

Microdevices (or often referred to as microfluidic devices) may be adapted to carry out a number of different separation techniques. Capillary electrophoresis (CE), for example, separates molecules based on differences in the electrophoretic mobility of the molecules. Typically, microfluidic devices employ a controlled application of an electric field to induce fluid flow and or to provide flow switching. In order to effect reproducible and/or high-resolution separation, a fluid sample ‘plug,’ a predetermined volume of fluid sample, must be controllably injected into a capillary separation column or conduit. For fluid samples containing high molecular weight charged biomolecular analytes such as DNA fragments and proteins, microdevices containing a capillary electrophoresis separation conduit a few centimeters in length may be effectively used in carrying out sample separation of small volumes of fluid sample having a length on the order of micrometers. Once injected, high sensitivity detection such as laser-induced fluorescence (LIF) may be employed to resolve a separated fluorescently-labeled sample component.

For samples containing analyte molecules with low electrophoretic differences, such as those containing small drug molecules, the separation technology of choice is often based LC, and particularly HPLC. As described, in LC, separation occurs when the mobile phase carries sample molecules through the stationary phase where sample molecules interact with the stationary phase surface. The velocity at which a particular sample component travels through the stationary phase depends on the component's partition between mobile phase and stationary phase.

Among other desired results, it is useful to provide separated analytes to a detector. As will be appreciated, the better the resolution of the absorption peaks of the analytes that is obtained, the more accurate is the liquid chromatography in analyzing a sample. One way to improve the separation and thus the resolution of the absorption peaks is to improve the retention behavior of the stationary phase. Unfortunately, in many known microfluidic devices, improving the retention behavior has proven difficult mostly due to the limitations of known materials used for the stationary phase.

What is needed, therefore, is a microfluidic device that provides improved retention and emission and absorption data resolution in liquid chromatography applications.

### BRIEF DESCRIPTION OF THE DRAWINGS

The present teachings are best understood from the following detailed description when read with the accompanying drawing figures. The features are not necessarily drawn to scale. Wherever practical, like reference numerals refer to like features.

FIG. 1 is a perspective view of a microfluidic device in communication with a detector in accordance with a representative embodiment.

FIG. 2A is an exploded perspective view of a device comprising a microfluidic device and a rotary flow switch in accordance with a representative embodiment.

FIG. 2B is a top view of a portion of the microfluidic device in accordance with representative embodiment.

FIG. 2C is a top view of a rotary flow switch in accordance with representative embodiment.

FIG. 3 is a conceptual view showing the in-situ polymerization forming an organic polymer-based monolithic separation medium in accordance with representative embodiment.

FIG. 4 is a graphical representation of absorption versus time for a liquid chromatograph at different mobile phase pressures in accordance with a representative embodiment.

FIG. 5 is a graphical representation of absorption versus time for a liquid chromatograph at different mobile phase pressures in accordance with a representative embodiment.

FIG. 6 is a graphical representation of absorption versus time for a liquid chromatograph at different mobile phase pressures in accordance with a representative embodiment.

FIG. 7 is a flow-chart of a method of operating an LC device in accordance with a representative embodiment.

### DEFINED TERMINOLOGY

It is to be understood that the terminology used herein is for purposes of describing particular embodiments only, and is not intended to be limiting.

As used in the specification and appended claims, the terms ‘a’, ‘an’ and ‘the’ include both singular and plural referents, unless the context clearly dictates otherwise. Thus, for example, ‘a device’ includes one device and plural devices.

In this specification and in the claims that follow, reference will be made to a number of terms that shall be defined to have the following meanings:

The term ‘LC’ as used herein refers to a variety of liquid chromatography devices including, but not limited to HPLC devices;

The term ‘fluid-transporting feature’ as used herein refers to an arrangement of solid bodies or portions thereof that direct fluid flow. Fluid-transporting features include, but are not limited to, chambers, reservoirs, conduits, channels and ports.

The term ‘controllably introduce’ as used herein refers to the delivery of a predetermined volume of a fluid sample in a precise manner. A fluid sample may be ‘controllably introduced’ through controllable alignment of two components (i.e., fluid-transporting features) of a microfluidic device;

The term ‘flow path’ as used herein refers to the route along which a fluid travels or moves. Flow paths are formed from one or more fluid-transporting features of a microdevice;

The term ‘conduit’ as used herein refers to a three-dimensional enclosure formed by one or more walls and having an inlet opening and an outlet opening through which fluid may be transported;

The term ‘channel’ is used herein to refer to an open groove or a trench in a surface. A channel in combination with a solid piece over the channel forms a conduit; and

The term ‘fluid-tight’ is used herein to describe the spatial relationship between two solid surfaces in physical contact such that fluid is prevented from flowing into the interface between the surfaces.

### DETAILED DESCRIPTION

In the following detailed description, for purposes of explanation and not limitation, representative embodiments disclosing specific details are set forth in order to provide a thorough understanding of the present teachings. Descriptions of known systems, devices, materials, methods of operation and methods of manufacture may be omitted so as to avoid obscuring the description of the example embodiments. Nonetheless, systems, devices, materials and methods that are within the purview of one of ordinary skill in the art may be used in accordance with the representative embodiments.

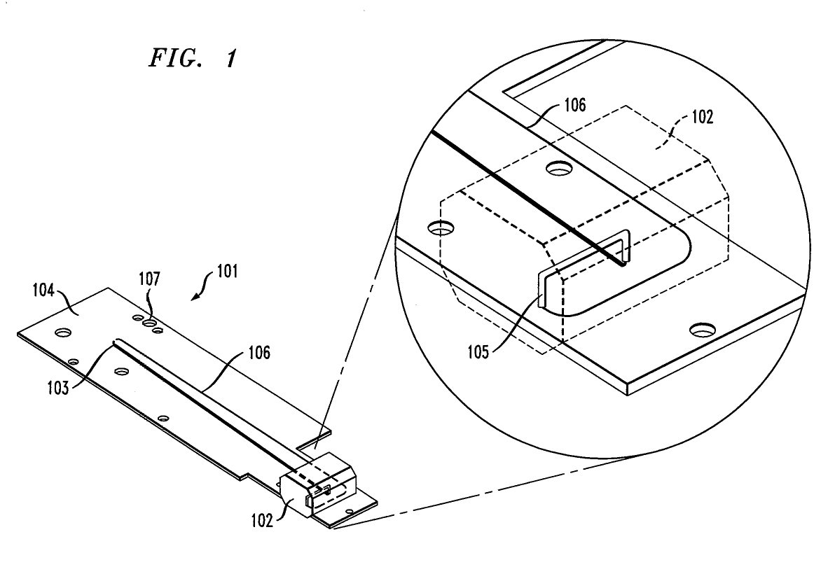

FIG. 1 is a perspective view of a microfluidic device 101 in communication with a detector 102 in accordance with a representative embodiment. As is known, a variety of detectors may be used in LC applications to provide a chromatogram for a sample. As such, it is contemplated that the detector 102 may be one of: a refractive index (RI) detector; an ultra-violet (UV) detector; a UV-Visible Light (UV-Vis) detector; a fluorescent detector (e.g., LIF detector); a radiochemical detector; an electrochemical detector; a near-infra red (Near-IR) detector; a mass spectroscopy (MS) detector; a nuclear magnetic resonance (NMR) detector; and a light scattering (LS) detector. It is emphasized that other types of detectors may be used. In the interest of ease of description, the detectors of the representative embodiments are absorption-type detectors that provide chromatograms of the radiation absorbed by the analytes of a sample.

A separation medium 103 is disposed in a substrate 104 of the device. The separation medium 103 illustratively comprises an organic polymer-based monolithic separation column provided in the substrate between conduits (not shown) where a sample for analysis and a mobile phase are introduced. As described more fully herein, the separation medium 103 comprises a conduit in a substrate having an organic-based (sometimes referred to herein as ‘organic’) separation material (not shown in FIG. 1) located in the conduit. The conduit with the organic separation material therein may be referred to herein as the ‘separation column.’

As will become clearer as the present description continues, the substrate 104 may comprise more than one layer, with one or more channels provided in at least one of the layers. The mobile phase and the sample-containing analytes are controllably introduced at a selected flow rate into conduits in the substrate 104 via a rotary flow switch (not shown in FIG. 1). The mobile phase and sample traverse the separation medium 103 and are introduced into a conduit 105 within the detector 102 where their absorption of electromagnetic radiation is monitored by the detector 102. The sample and mobile phase flow through the separation medium 103 at a prescribed flow rate and are provided to a return conduit 106 for expulsion as waste. For ease of initial description, the microfluidic device 101 is shown having only a few conduits. This is merely illustrative, and it is noted that as described more fully herein, additional fluid-transporting features may be provided in the microfluidic device 101. For instance, as described more fully below, flow restrictors are provided to enable the selective modulation of the pressure of the mobile phase and thus the pressure of the sample through the separation medium.

In representative embodiments, the microfluidic 101 is provided in an LC and the detector 102 is a part of that LC. The type of detector 102 and the other components of the LC required for analysis of the sample are governed by a variety of factors. As such a comparatively wide variety of detectors may be used in the representative embodiments. For example, high sensitivity detection (such as by LIF) of the sample may be employed to resolve a separated fluorescently-labeled sample component. Details the sample emission and absorption detection are generally omitted to avoid obscuring the description of the representative embodiments.

The microfluidic device 101 shares many features, dimensions, materials, methods of fabrication and methods of operation described in commonly owned U.S. Pat. No. 7,128,876 entitled ‘Microdevice and Method for Component Separation’ to Hongfeng Yin, et al.; commonly owned U.S. Pat. No. 6,845,968 entitled ‘Flow-Switching Microdevice’ to Kileen, et al.; and commonly owned U.S. patent application Ser. No. 12/022,684 (Attorney Docket Number 10060671-02), entitled ‘Microfluidic Device for Sample Analysis’ to Yin, et al., and filed on Jan. 30, 2008. The disclosures of these patents and patent application are specifically incorporated herein by reference. Repetition of the features, dimensions, materials, methods of fabrication and methods of operation is generally avoided herein to avoid obscuring the description of representative embodiments.

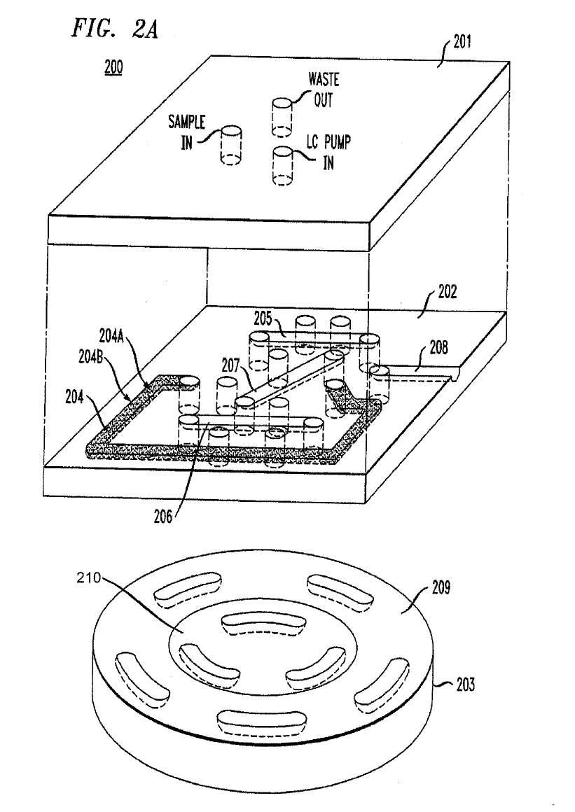

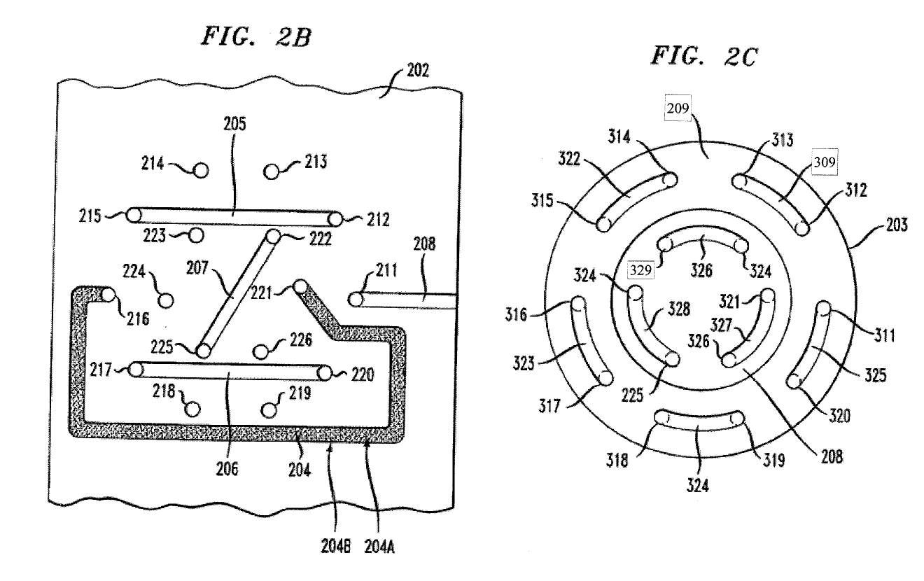

FIG. 2A is a perspective view of a device 200 comprising a microfluidic device and a rotary flow switch element 203 in accordance with a representative embodiment. The microfluidic device comprises a first substrate 201 and a second substrate 202. The rotary flow switch 203 is disposed in contact with the surface of the second substrate 202 remote from first substrate 201. Alternatively, there may be one or more layers (not shown) disposed between the rotary flow switch 203 and the surface of the second substrate 202 remote from the first substrate 201. Notably, the substrates 201, 202 and switch 203 are shown in an uncoupled or partially exploded arrangement to facilitate description of certain features of each. As described more fully herein and in the incorporated patent application and patents, when coupled together, the substrates 201, 202, the rotary flow switch 203 and any intervening layers (not shown) form fluid-tight conduits from channels formed in each.

The first substrate 201 and the second substrate 202 can be laminated to provide conduits in a manner described in the incorporated application and patents. Alternatively, the microfluidic device may comprise a single substrate having conduits described in connection with the substrate 202. In particular, some channels formed in the substrate 202 are converted into conduits when the first substrate 201, or the fluid switch 203, or both, are brought in fluid-tight communication with the second substrate 202. Naturally, as needed inlet and outlet conduits may be formed in the second substrate 202 to provide a flow path to/from the channel. In this manner, the first substrate 201 can be foregone and the microfluidic device may comprise the second substrate alone. Still other embodiments are contemplated in which the microfluidic device comprises layers in addition to first and second substrates 201, 202.

The second substrate 202 comprises an organic polymer-based monolithic separation medium 204. In a representative embodiment, the organic polymer-based monolithic separation medium 204 comprises an organic polymer-based separation material 204A provided in a fluid-transporting feature 204B. The organic polymer-based separation medium 204 comprises an inlet at one end and an outlet at another end. As described more fully herein, the organic polymer-based monolithic separation medium 204 is illustratively formed in-situ by polymerizing monomers in the fluid-transporting feature 204B in the second substrate 202.

In addition to flow paths operative to provide a minimum fluid impedance or a baseline of fluid impedance, the second substrate 202 also includes a first flow restrictor 205 and a second flow restrictor 206 formed from fluid-transporting features in the substrate 202, with each flow restrictor 205, 206 having an inlet and an outlet. Like other fluid-transporting features of the representative embodiments, the flow restrictors 205, 206 can have a variety of configurations, such as a straight, serpentine, spiral, or any tortuous path. However, the flow restrictors 205, 206 are also designed to introduce different degrees of fluid impedance in the flow path of the mobile phase to provide a different pressure in the separation medium 204 for a given flow rate. In certain embodiments, fluid impedance can be effected by providing a fluid-transporting feature in the substrate 202 with smaller cross-sectional sectional area than other fluid-transporting features in the flow path. Moreover, and as described more fully herein, the rotary flow switch 203 allows for the selection of a particular flow restrictor between flow restrictors 205, 206 or a baseline or minimum flow impedance through another fluid-flow feature, and thus for the selection of a particular pressure in the separation column for the fluid flow of a particular LC test. In an embodiment, a fluid-transporting feature with a greater cross-sectional area than that of an illustrative flow restrictor can provide a baseline or a minimum flow impedance.

A sample loading channel 207 is provided in the second substrate 202 as shown and is in fluid tight communication with the conduit in first substrate 201, labeled ‘Sample In’. The sample loading channel 207 may be packed with suitable material for sample enrichment prior to LC separation. A sample is controllably introduced into channel 207. After proper rotation of the rotary flow switch 203, the sample is introduced into the separation medium 204. After traversing the separation medium 204 and the selected flow restrictor 205, 206, the sample and mobile phase are introduced into an output conduit 208, which is coupled to an outlet in the second substrate 202. The outlet of the output conduit 208 is provided to a detector, such as described in connection with FIG. 1. Notably, the output can be sprayed into a detector (e.g., a mass spectrometry electrospray) or can be introduced into another fluid-transporting feature (e.g., conduit 105 (FIG. 1)).

The rotary flow switch 203 of the representative embodiment comprises an outer rotor 209 and an inner rotor 208. As described in the incorporated patent application to Yin, et al., the rotors 208, 209 have fluid-transporting features operative to controllably introduce the sample and the mobile phase into the conduits of the second substrate 202. In a representative embodiment, the outer rotor 209 is used to controllably introduce the mobile phase through a flow restrictor (e.g., 205 or 206) or other fluid-transporting feature in the microfluidic device; and the inner rotor 208 is used to controllably introduce the sample into separation medium 204. The conduits and channels shown in FIG. 2A and their respective functions are described more fully in connection with FIGS. 2B and 2C.

FIG. 2B is a top view of a portion of the microfluidic device in accordance with representative embodiment; and FIG. 2C is a top view of the rotary flow switch 203 in accordance with representative embodiment. Connections between fluid-transporting features (labeled 204 through 226) of the second substrate 202, and fluid-transporting features (labeled 311 through 328) of the rotary flow switch 203 may be made via a variety of configurations. An explanation of the fluid flow in illustrative configurations of the rotors 209, 210 is best understood by describing FIGS. 2B and 2C together.

As noted, the rotary flow switch 203 is disposed in contact with the second substrate 202 to effect the controllable introduction of the mobile phase and sample. The surface of the rotary flow switch 203 switch shown in FIG. 2C is in contact with the opposing surface of the surface of the second substrate 202 shown in FIG. 2B, with the fluid-transporting features thereof aligned in a manner described below. With the rotors 209, 210 arranged as shown, the mobile phase is controllably introduced via a conduit ‘LC Pump In’ (FIG. 2A) into a conduit 226 that is aligned with and in fluid tight communication with a port 336 of a channel 327 on the inner rotor 209. The mobile phase flows through the channel 327 on rotor 210 to a port 321. The port 321 is in fluid tight communication with conduit 221 that extends through the substrate 202. The conduit 221 provides the inlet to the organic polymer-based monolithic separation medium 204. The mobile phase flows from an outlet 216 of the organic polymer-based monolithic separation medium 204 and to a port 316 of the outer rotor 209. The mobile phase flows across a channel 323 to a port 317 and then to conduit 217 in communication with the second flow restrictor 206. After flowing through the flow restrictor 206, the mobile phase flows through a conduit 220 and to a port 320 on the outer rotor 209. From the port 320, the mobile phase flows to a conduit 211 in communication with the output conduit 208 and then to the detector as described previously. After passing through the detector, the sample and mobile phase are returned as waste through a conduit 224, which is in fluid tight communication with a conduit labeled ‘Waste Out’ in FIG. 2A.

The sample is controllably introduced into the sample channel 207 through a conduit 223, which is in fluid tight communication with the conduit labeled ‘Sample In’ in FIG. 2A. The sample is controllably introduced into the mobile phase by rotating the inner rotor 208 clockwise 60° so that a port 321 is aligned with the conduit 221 of the organic polymer-based monolithic separation medium 204.

By rotating the outer rotor 209 clockwise 36°, the first flow restrictor 205 can be engaged. Specifically, by rotating the outer rotor 209 clockwise in this manner, conduit 216 at an end of the organic polymer-based monolithic separation medium 204 is aligned with an inlet 217 of the outer rotor 209. The mobile phase traverses a channel 323 on the outer rotor 209, and passes through port 316, which is now in communication with an inlet 215 of the first flow restrictor 205. With port 312 in communication with conduit 211 by this arrangement, the mobile phase is provided to the output conduit 208.

In a representative embodiment, the second flow restrictor 206 provides a greater resistance to fluid flow than the first flow restrictor 205. For a given flow rate, this results in a greater pressure in the flow path of the mobile phase described above. By contrast, selection of the first flow restrictor 205 results in a comparatively lower pressure in the flow path of the mobile phase. Moreover, a flow path that does not include one of the flow restrictors 205, 206, may be selected to provide a lower pressure (e.g., a minimum pressure or a baseline pressure) for a selected flow rate. The selection of the pressure for the flow of the mobile phase and the ability to change the pressure by a comparatively simple adjustment of the outer rotor 209 provides benefits in LC applications. Some of these benefits are described more fully herein, while others will become apparent to those of ordinary skill in the art upon review of the present disclosure.

In order to simplify description of the present teachings, the embodiments described include only two fluid restrictors that can be selectively engaged. It is emphasized that use of two flow restrictors is intended to be merely illustrative and in no way limiting. The present teachings also contemplate the inclusion of more or fewer than two flow restrictors; and one or more fluid-transporting features that provides a baseline or a minimum fluid impedance, with the flow-restrictor(s) and fluid-transporting feature(s) selectively engaged through adjustment of the fluid switch 203. Notably, additional ports, channels and conduits, and arrangements thereof on the switch 203 will be required to effect the alignment of to the additional flow restrictors.

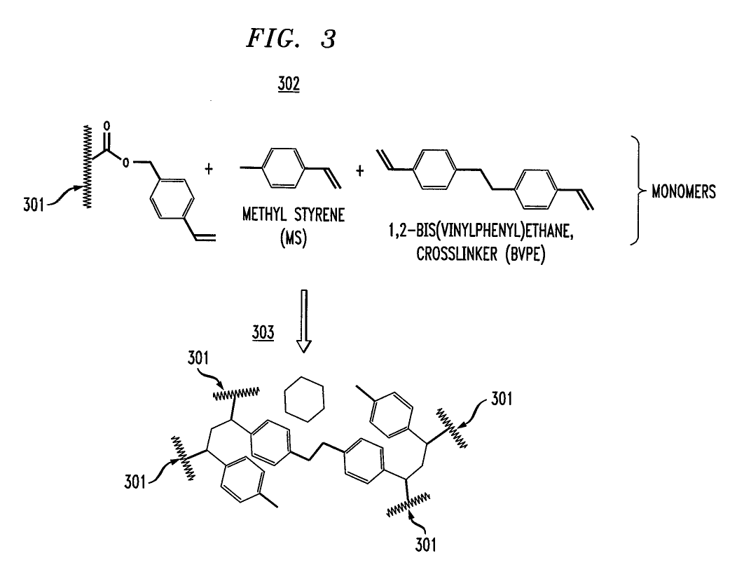

FIG. 3 is a conceptual view showing the in-situ polymerization used to form an organic polymer-based monolithic separation medium in accordance with representative embodiment. As noted, the organic polymer-based monolithic separation medium can be formed by in-situ polymerization of monomers, cross-linkers and inert porogenic solvents in a fluid-transporting feature (e.g., a conduit or a channel) formed in a substrate of the microfluidic device. For example, in-situ polymerization presently described in a conduit or channel in substrate 104 and second substrate 202 shown in FIGS. 1 and 2A can be used to fabricate organic monolithic separation media 108 and 204, respectively.

In representative embodiments, monomers 302 are provided in a fluid-transporting feature (e.g., a conduit or a channel) having a wall 301 and are polymerized in such a way as to incorporate the wall. As shown in FIG. 3, the wall 301 has been chemically modified prior to introduction of the monomers to have an extension that contains a double bond. During the polymerization process, the dangling bonds of the modified walls are incorporated into the resultant polymer network. Further details of the process for fabrication the organic-based monolithic separation media are provided in commonly-owned U.S. patent application Ser. No. 11/820,856, entitled “Microfluidic Devices Comprising Fluid Flow Paths Having A Monolithic Chromatographic Material” to Karla Robotti. This application, which was filed on Jun. 20, 2007, is specifically incorporated herein by reference.

In accordance with certain representative embodiments, polymers 303 comprise methylstyrene-vinylbenzene derivatives and form a network between the walls 301 of the fluid-transporting feature. It is emphasized that the use of methylstyrene-vinylbenzene derivatives for the organic polymer-based monolithic separation media is merely illustrative and that other materials are contemplated. Other materials contemplated include, but are not limited to styrene-vinylbenzenes, polymethacrylates and methacrylate copolymerizates. As described more fully herein, these formulations have allowed successful separations of both large and very small molecules.

Among other benefits, the organic polymers of the monolithic separation media of the representative embodiments provide a skeleton structure with macropores that serve as through-pores for all of the mobile phase. This allows the analytes to be transported to the meso/micro pores on the skeletal network for separation. This significantly enhances mass transfer rates and allows much higher flow rates while keeping a low back pressure. Moreover, and as is known, in some instances it is useful to reduce the flow rate of the mobile in LC testing, particularly when the sample volume, or the analyte size, or both are small. A comparatively low flow rate can foster a higher retention time and ultimately better resolution and selectivity. As described more fully below, the organic polymer-based monolithic separation medium of the representative embodiments provides greater surface area at higher pressure. Thus, retention can be improved even at comparatively low flow rates.

In addition, the separation medium of the representative embodiments has a greater porosity and permeability compared to traditional bead-packed columns. As such, in use in LC applications, the organic polymer-based monolithic separation medium provides for a convection flow system on a continuous bed as opposed to a diffusion flow system with beads (with slow mass transfer). Thus, a high speed separation may be realized without compromising the resolution. Moreover, the organic polymer-based medium of representative embodiments is flexible and therefore deforms under pressure with a pressure-dependent deformation. This allows the separation characteristics of the medium to be defined by the selected pressure. Among other benefits, Applicants have discovered improved retention, plate height, resolution and separation through the modulation of pressure of the mobile phase when using organic polymer monoliths.

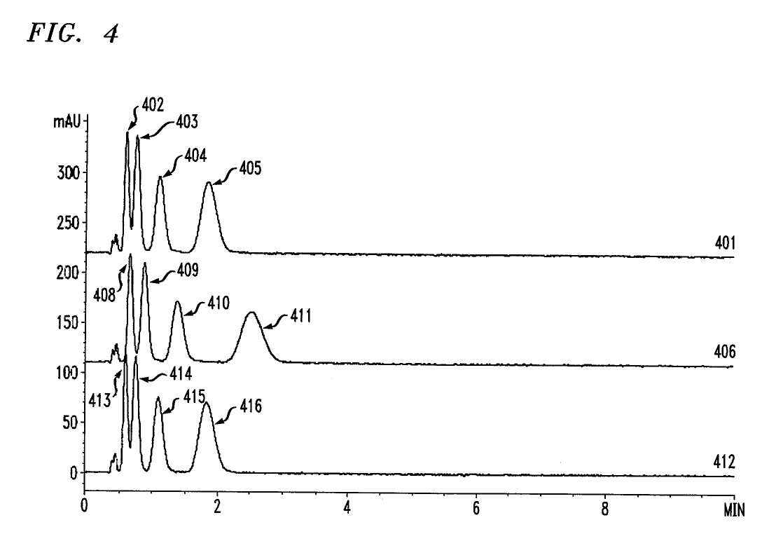

FIGS. 4-6 are chromatograms showing absorption versus time at different operating pressures using a microfluidic device with an organic polymer-based monolithic separation medium in accordance with representative embodiments. Notably, in the representative embodiments described presently, the organic separation medium comprises polymethylstyrene-co-vinylbenzene.

Certain quantitative indicia are normally used to describe the chromatograms and, as a result, the performance characteristics of the microfluidic device in an LC application. These indicia are known to those in the art and as such are only briefly summarized herein. One such indicium is known as resolution. Resolution is the distance between peak centers divided by average base width of the peaks and provides a measure of how well the peaks are separated from one another. Another quantitative indicium used in liquid chromatography is number of ‘plates’ and is a term of art with roots in distillation theory. The number of plates is a measure of band broadening within the LC system and is equal to square quotient of the rate of retention volume and the peak width times a factor. In general, the number of plates is an indication of the efficiency of the separation column.

A quantity related to the number of plates and also having roots in distillation is the plate height. The plate height is equal to the quotient of the length of the separation medium (column) and the plate number. The plate height is a useful measure of the efficiency of the separation column. In general, the lower the plate height, the narrower the peaks; the more readily discerned are the peaks for individual analytes; and the greater the efficiency of the column.

Another measure of the performance of a separation column is the separation factor or selectivity. This is a measure of the net retention time ratio for two absorption peaks. In general, it is useful to increase the selectivity to the extent possible. Finally, the retention time (tₒ) of a peak that has no retention is a useful quantitative measure. This term is also known as the retention time of the void volume or the void time, and provides a measure of the time through the separation column for an unretained sample. In general, it is useful to increase the retention time to the extent possible.

FIG. 4 is a graphical representation of absorption versus time of a liquid chromatograph at constant flow rate and different mobile phase pressures in accordance with a representative embodiment. It is noted that to properly discern the results, the chromatograms have been separated vertically, thus providing a qualitative comparison of the peaks rather than a true quantitative comparison.

Chromatogram 401 represents the absorption peaks of analytes provided at the set flow rate and at a first mobile phase pressure. The flow rate and pressure serve as a baseline for other absorption peaks. Notably, the retention time for an unretained peak is 0.409. The resolution between peaks 402 and 403 is 0.875 and between peaks 404 and 405 is 1.34. Moreover, the selectivity between peaks 402, 403 is 1.94 and between peaks 404, 405 are 2.07.

Chromatogram 406 represents the absorption peaks of analytes provided at the set flow rate and at a second mobile phase pressure. Notably, the analytes/mobile phase are the same as those providing the absorption data of chromatogram 401, but the pressure of the mobile phase is greater than the first mobile phase pressure that garnered the data of chromatogram 401. The pressure variation may be effected using the rotary flow switch 203 described above to select a different flow restrictor having a great resistance to fluid flow. For example, the change in mobile phase pressure may be realized by changing from no flow restrictor, which provides, for example, a minimum or a baseline pressure, to one of the flow restrictors 205, 206; or from one restrictor to another (e.g., from flow restrictor 205 to flow restrictor 206).

Qualitatively, from a review of chromatogram 406, one can recognize that the absorption peaks are separated more in time; and do not have as much overlap as the absorption peaks of chromatogram 401. Quantitatively, the retention time of an unretained peak is 0.425. The resolution between peaks 408 and 409 is 1.04 and between peaks 410 and 411 is 1.56. Moreover, the selectivity between peaks 408, 409 is 2.03 and between peaks 410, 411 is 2.16. As will be appreciated, the resolution and selectivity are improved for the same flow rate and increased mobile phase pressure. Furthermore, the increased pressure also results in a lower plate height and improved efficiency.

Applicants surmise that the increased retention time, separation and resolution results from the increased pressure's opening the elastic pores of the organic polymer network of the organic polymer-based monolithic separation medium. This increases the surface area, thereby providing more area for molecular separation of the analytes as they traverse the medium. The increased retention time with increasing pressure implies that the monolith has a lower linear velocity at higher pressure. This is a result of the actual interstitial and interstitial porosities within the organic polymer-based monolithic separation medium.

Chromatogram 412 represents the absorption versus time of the same analytes/mobile phase at the same set flow rate as chromatograms 401 and 406 and with the mobile phase pressure restored to that of chromatogram 401 after chromatogram 406 was taken. The pressure variation may be effected using the rotary flow switch 203 described above to switch back to no flow restrictor or to the previous flow restrictor. For example, the change in mobile phase pressure may be realized by changing from the selected flow restrictor (205 or 206) selected for higher pressure, back to no flow restrictor or to flow restrictor selected for lower pressure (i.e. following the previous example, from flow restrictor 206 back to flow restrictor 205).

As will be appreciated from a comparison of the absorption peaks of the chromatogram 412 to those of chromatogram 401, the retention time, the resolution and the selectivity of are substantially identical. Chromatogram 412 is provided to show that in spite of being expanded by the greater pressure in the test run resulting in the chromatogram 406, the separation medium's function is substantially the same as before the higher pressure test run captured in chromatogram 401. Applicants surmise that the polymer network relaxes/returns to its previous state after the pressure variation to the lower pressure.

The ability to select a greater mobile phase pressure and then select a lower mobile phase pressure (i.e., to modulate the pressure) for a set flow rate allows the operator to modulate the retention behavior of the organic polymer-based monolithic separation medium. This potentially affords a number of useful applications. One such application may be to release a sample and mobile phase from a system after running a test by selecting a lower pressure of operation. This reduction in pressure will cause the polymer network to relax and thereby reduce the retention time of the mobile phase, allowing its release in a more expeditious manner.

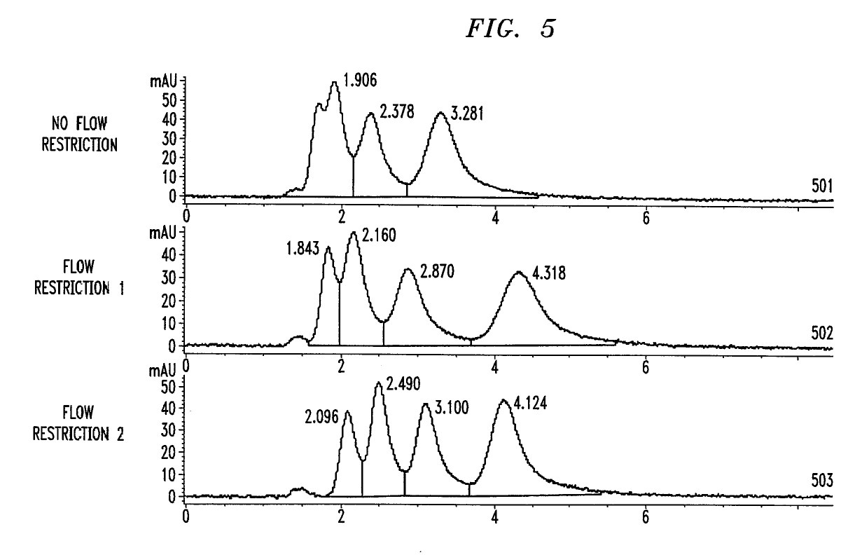

FIG. 5 is a graphical representation of absorption versus time for a liquid chromatograph at a set flow rate and different mobile phase pressures in accordance with a representative embodiment. The sample in each case was substantially identical and comprised an isocratic test mix of four parabens, with comparatively small molecular size. The test runs were made at the same flow rate but with different mobile phase pressures. A microfluidic device having at least two flow restrictors such as described in connection with representative embodiments could be used to run each test. The rotary flow switch 203 could be used to change the flow path to selectively engage flow restrictors and to bypass flow restrictors to realize desired pressures as described presently.

A first chromatogram 501 is of a first test run of the isocratic test mix with a selected flow rate at a nominal pressure, generated without engaging a flow restrictor. A second chromatogram 502 is of a second test run of the isocratic mix with the selected flow rate with the pressure of the mobile phase increased over that of the nominal pressure in the first run by changing the flow path so that the mobile phase traverses a first flow restrictor. A third chromatogram 503 is of a third test run of the isocratic mix with the selected flow rate with the pressure of the mobile phase increased compared to the nominal pressure and the pressure of the second run by changing the flow path so that the mobile phase traverses a second flow restrictor.

From a review of chromatograms 501, 502 and 503, it is apparent that the corresponding four absorption peaks of the analytes (in this case the four parabens) have different resolution and selectivity. Moreover, the retention time differs from one chromatogram to the next. Notably, the resolution, selectivity and retention time are increased with increasing pressure at the selected flow rate. This is consistent with the characteristics of organic polymer-based monolithic separation media described previously.

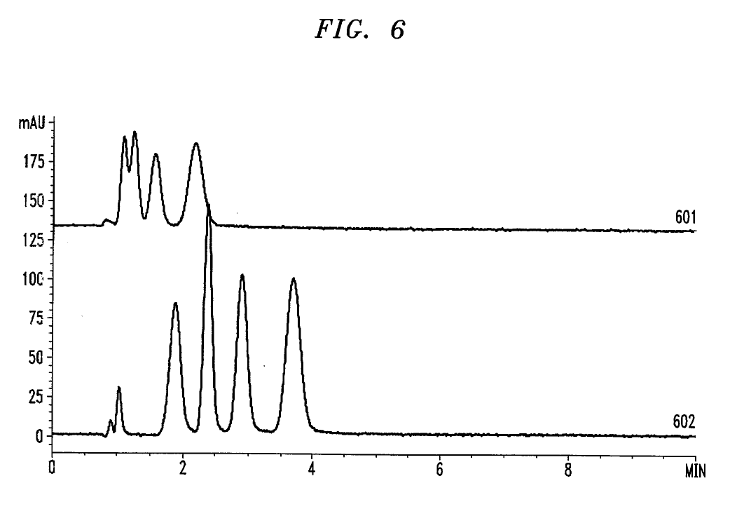

FIG. 6 is a graphical representation of absorption versus time for a liquid chromatograph at a set flow rate and different mobile phase pressures in accordance with a representative embodiment. Chromatogram 601 shows absorption versus time for a four component sample run at a selected flow rate and first pressure. Chromatogram 602 shows absorption versus time for a four component sample run at the same flow rate but at a greater pressure. The retention, resolution, selectivity and plate height of chromatogram 602 are significantly improved compared to those of chromatogram 601. Moreover, the higher pressure run was completed and shortly thereafter, the lower pressure run was completed. This is evidence of the resilience of the organic polymer-based monolithic separation medium, which can be stretched during a higher pressure run, but will relax to its original configuration when the pressure is reduced. The ability to change the pressure of the mobile phase from higher pressure to lower pressure comparatively easily, with no loss of function of the separation column, and multiple times using the microfluidic device of representative embodiment will allow users to determine the optimal flow rate.

As noted previously, in some instances it is useful to have a comparatively high flow rate, while in others a comparatively low flow rate is desired. The selection of an optimal flow rate to garner the greatest efficiency is determined from the so-called van Deemter plot. As is known, the van Deemter plot is a graph of the plate height versus linear velocity. The flow rate that affords the greatest efficiency may then be selected from the plot. However, if for some reason, it is difficult to operate an LC device at the optimal flow rate, the ability to select multiple pressures and flow rates in an efficient manner using a microfluidic device with a rotor of the representative embodiments affords significant advantages of functionality of the LC.

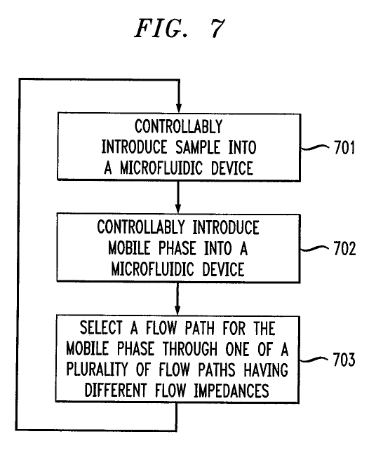

FIG. 7 is a flow-chart of a method of operating an LC device in accordance with a representative embodiment. Illustratively, the method may be implemented using the microfluidic device and rotary flow switch 203 described previously. Alternatively, the method may be implemented using other microfluidic devices and flow controllers. At step 701, a sample is controllably introduced in the microfluidic device. At step 702, a mobile phase is controllably introduced in the microfluidic device at a flow rate. At step 703, a flow path for the mobile phase through one of a plurality of flow paths having different flow impedances to obtain a first pressure for the mobile phase through an the organic polymer-based monolithic separation medium 204. The selected flow path may include one of the flow restrictors 205, 206, or may include another fluid-transporting feature that provides the desired first pressure. For example, rather than traversing one of the flow restrictors 205, 206, the flow path may include a fluid-transporting feature that provides a baseline pressure for the LC test undertaken. After the test is completed at the selected first pressure, the method may be repeated beginning at step 701. In a subsequent sequence of the method, the same analytes may be provided in the sample.

At step 703, however, another flow path may be selected to provide a second pressure for the mobile phase. This pressure may be greater than, or less than the first pressure. After completion of the second test, the method may be repeated beginning at step 701. In this manner, a plurality of chromatograms (e.g., the chromatograms shown in FIGS. 4-6) may be garnered for different pressures or different flow rates, or both.

In view of this disclosure it is noted that the methods and microfluidic devices can be implemented in keeping with the present teachings. Further, the various components, materials, structures and parameters are included by way of illustration and example only and not in any limiting sense. In view of this disclosure, those skilled in the art can implement the present teachings in determining their own applications and needed components, materials, structures and equipment to implement these applications, while remaining within the scope of the appended claims.

1. In a liquid chromatography (LC) device, a method comprising:
controllably introducing a sample in a microfluidic device;
controllably introducing a mobile phase in the microfluidic device at a flow rate; and
selecting a flow path for the mobile phase through one of a plurality of flow paths having different flow impedances to obtain a first pressure for the mobile phase before introducing the mobile phase into an organic polymer-based monolithic separation medium.

2. A method as claimed in claim 1, further comprising, after the selecting the flow path, and before introducing, selecting another flow path for the mobile phase to obtain a second pressure for the mobile phase through the organic polymer-based monolithic separation medium.

3. A method as claimed in claim 2, wherein the first pressure is greater than the second pressure, and the organic polymer-based monolithic separation medium provides a greater retention time at the first pressure than at the second pressure.

4. A method as claimed in claim 1, wherein one or more of the plurality of flow paths comprises a flow restrictor.

5. A method as claimed in claim 1, wherein the organic polymer-based monolithic separation medium comprises an organic polymer-based material comprising a network of interconnected macro-pores and meso-pores.

6. A method as claimed in claim 5, wherein the organic polymer-based material comprises one of: a styrene-vinylbenzene polymer; a methylstyrene-vinylbenzene polymer; a polymethacrylate polymer; and a methacrylate-co-polymerizate.

7. A method as claimed in claim 1, wherein the selecting the flow path further comprises providing a rotary flow switch; and selecting a first position of the rotary flow switch.

8. A method as claimed in claim 7, wherein the rotary flow switch comprises a first rotor and a second rotor and the controllably introducing the sample further comprises:
selecting a first position of a second rotor of the rotary flow switch;
injecting the sample into an opening of the second rotor of the rotary flow switch; and
rotating the second rotor to a second position to introduce the sample into the organic polymer-based monolithic separation medium.

9. A microfluidic device, comprising:
fluid-transporting features;
an organic polymer-based monolithic separation medium;
a first flow restrictor configured to provide a first fluid impedance; and
a second flow restrictor configured to provide a second fluid impedance, wherein each of the first and second flow restrictors are adapted to selectively engage at least one of the fluid-transporting features coupled to the organic polymer-based monolithic separation medium.

10. A microfluidic device as claimed in claim 9, wherein the first flow restrictor is adapted to provide a first pressure for the mobile phase at a flow-rate of fluid.

11. A microfluidic device as claimed in claim 10, wherein second flow restrictor is adapted to provide a second pressure for the mobile phase at the flow rate.

12. A microfluidic device as claimed in claim 9, wherein at least one of the fluid transporting features is adapted to receive the mobile phase.

13. A microfluidic device as claimed in claim 9, wherein at least one of the fluid transporting features is adapted to receive a sample.

14. A microfluidic device as claimed in claim 9, wherein the organic polymer-based monolithic separation medium comprises a network of interconnected macro-pores and meso-pores.

15. A microfluidic device as claimed in claim 13, wherein the organic polymer-based monolithic separation medium provides a greater retention at a higher pressure than at a lower pressure.

16. A microfluidic device as claimed in claim 13, wherein the organic polymer-based material comprises one of: a styrene-vinylbenzene polymer; a methylstyrene-vinylbenzene polymer; a polymethacrylate polymer; and a methacrylate-co-polymerizate.

17. A device for performing liquid chromatography, comprising:
a microfluidic device, comprising: fluid-transporting features; an organic polymer-based monolithic separation medium; a first flow restrictor configured to provide a first fluid impedance; and a second flow restrictor configured to provide a second fluid impedance, wherein each of the first and second flow restrictors are adapted to selectively engage at least one of the fluid-transporting features coupled to the organic polymer-based monolithic separation medium; and
a rotary flow switch operative to selectively engage the fluid-transporting features of the microfluidic device to introduce a mobile phase and a sample to the microfluidic device.

18. A device as claimed in claim 17, wherein the rotary flow switch comprises a first rotor and a second rotor, the first rotor being adapted to introduce the mobile phase to the microfluidic device and the second rotor being adapted to introduce the sample to the microfluidic device.

19. A device as claimed in claim 17, wherein the first flow restrictor is adapted to provide a first pressure for the mobile phase at a flow-rate of fluid.

20. A device as claimed in claim 19, wherein the second flow restrictor is adapted to provide a second pressure for the mobile phase at the flow rate.

21. A device as claimed in claim 17, wherein the organic polymer-based monolithic separation medium comprises a network of interconnected macro-pores and meso-pores.

22. A device as claimed in claim 17, wherein the organic polymer-based monolithic separation medium provides a greater retention at a greater pressure than at a lower pressure.
